(19) United States
(12) Patent Application Publication
(10) Pub. No.: US 2026/0210770 A1
(43) Pub. Date: Jul. 23, 2026

(54) AN ULTRA-LOW PRECIOUS METAL THERMOCOUPLE TEMPERATURE SENSOR

(71) Applicant: BASF Mobile Emissions Catalysts LLC, Iselin, NJ (US)

(72) Inventor: John Justin GROSSI, Fremont, CA (US)

(21) Appl. No.: 19/140,846

(22) PCT Filed: Dec. 19, 2023
(86) PCT No.: PCT/US2023/084761

§ 371 Date: Jun. 18, 2025

Related U.S. Application Data
(60) Provisional application No. 63/476,973, filed on Dec. 23, 2022.

(51) Int. Cl. G01K 1/12; G01K 7/06; G01K 13/02

(52) U.S. Cl. CPC G01K 1/12; G01K 7/06; G01K 13/02

(57) ABSTRACT

Disclosed is a temperature sensing device including a thermocouple having a pair of wires, a temperature measuring junction between the wires, and an insulator covering the wires and a. protective sheath. The protective sheath includes a sapphire tertiary sheath surrounding the wires, the temperature measuring junction, and the insulator of the thermocouple, a secondary sheath surrounding the tertiary sheath, and a primary sheath surrounding the secondary sheath.

### TECHNICAL FIELD

This invention relates to temperature sensing devices that require less precious metal content than conventional in-glass temperature sensing thermocouple designs without sacrificing performance life.

### SUMMARY

I provide a temperature sensing device including a thermocouple having a pair of wires, a temperature measuring junction between the wires, and an insulator covering the wires and a protective sheath. The protective sheath includes a sapphire tertiary sheath surrounding the wires, the temperature measuring junction, and the insulator of the thermocouple, a secondary sheath surrounding the tertiary sheath, and a primary sheath surrounding the secondary sheath.

### BRIEF DESCRIPTION OF DRAWINGS

Other objects and advantages of the present disclosure will become apparent to those skilled in the art upon reading the following description of embodiments and appended claims, in conjunction with the accompanying drawings, in which like reference numerals have been used to designate like elements, and in which:

FIG. 1 is a cross-sectional view of an exemplary thermocouple device.

FIG. 2A is cross-sectional view of an alternative exemplary thermocouple device.

FIG. 2B is a cross-sectional view of the alternative exemplary thermocouple device of FIG. 2A along line II-II.

The figures are for purposes of illustrating example embodiments, but it is understood that the inventions are not limited to the arrangements and instrumentality shown in the drawings. In the figures, identical reference numbers identify at least generally similar elements.

### DETAILED DESCRIPTION

Thermocouples are used in a variety of applications to sense temperature at a given location. A typical thermocouple comprises an external sheath and a pair of rod-shaped conductors disposed longitudinally within the sheath. Each conductor is of a dissimilar metallic material, and the two conductors are joined at a distal end within the sheath. An electrical insulation material also is packed about the rods within the sheath. The free ends of the conductors are connected to a detection instrument, such as a voltmeter, that measures the difference in potential created at the junction of the two metals. This difference in potential changes with temperature, thereby readily permitting the accurate detection of temperature at the junction point.

Thermocouples are used to measure the temperature of process fluids in a variety of industries, including, for example, the chemical, petroleum, and manufacturing industries, where they are exposed to harsh conditions. Using thermocouples in glass manufacturing presents a unique set of challenges. These factors include the very high industrial temperatures involved, the high viscosity and abrasiveness of flowing molten glass at these temperatures, and the chemical reactivity of both the glass itself and also of the atmosphere in which it is heated. Thermocouples in high temperature glass manufacturing processes tend to erode due to the harsh chemistry at the glass surface (at the interface between the combustion gasses and the glass) found in the furnaces and the erosive effect of the glass flow over the thermocouple body. Current designs for thermocouples utilize precious metal (PM) sheaths or thimbles to protect the thermocouple wire in the molten glass. However, PM costs are significant and, therefore, there is a need to provide a thermocouple design minimizes the need for PMs.

According to one or more embodiments described herein, systems, methods, and apparatus for a thermocouple are provided.

This disclosure provides a temperature sensing device suitable for use at high temperatures in a hostile environment such as molten glass, comprising thermocouple conductors held within a three-part protective sheath that has an ultra-low content of precious metals. Advantageously, the temperature sensing device of this disclosure is expected to have the same performance life as conventional in-glass thermocouple designs that utilize significantly more precious metal. Hence, this design will drastically reduce the cost of the product while providing the same performance life.

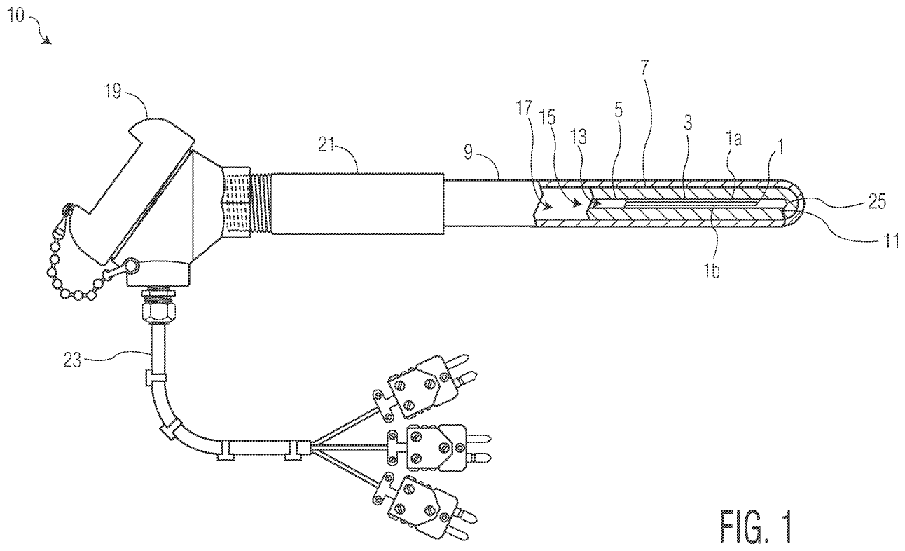

Referring now to FIG. 1, an exemplary temperature sensing device 10 is shown. The temperature sensing device 10 comprises a temperature sensor for measuring a temperature of an environment, such as a thermocouple 1 formed of a pair of wires 1a and 1b a pair of wires with a temperature measuring junction 25 between the wires. In one example, the environment includes physical material, such as molten glass. It will be appreciated that the environment may include any form of material such as solid, liquid, or gas. The wires 1a, 1b have dissimilar metal content such that a difference in electrical potential can develop between them when the thermocouple 1 is exposed to a heat source. The difference between the electrical potential of the two wires 1a, 1b, being representative of the temperature at the distal (hot) end, is measured. Various means are known to those of ordinary skill in the art for measuring the difference in electrical potential. Any of these methods can be used.

In an exemplary embodiment, wires la and 1b may both contain platinum and rhodium as their primary substituents with the amounts of platinum and rhodium being different in the two wires 1a, 1b. Suitable thermocouple wires are known in the art. Preferably, thermocouple 1 may be BASF's FIBRO® wire.

The thermocouple 1 is positioned inside a thermocouple insulator 3. Thermocouple insulator 3 may suitably be made from insulating materials known in the art.

The thermocouple 1 and thermocouple insulator 3 are, together, arranged within a protection means, such as protective sheath 11, which protects the thermocouple wire 1, 1b from molten glass and other detrimental materials. As shown in FIG. 1, the protective sheath 11 surrounds the thermocouple 1 and thermocouple insulator 3 and is mounted to a thermocouple head 19. In the depicted example, the protective sheath 11 is affixed to a threaded metal pipe 21, which is coupled by a mating threaded connection to the thermocouple head 19.

A proximal end (not shown) of the thermocouple 1 terminates inside the thermocouple head 19 and is electrically connected therein by a cold junction to additional lead wires 23 configured to connect with measuring circuitry (not shown), such as a voltmeter. The measuring circuitry determines the temperature difference between the temperature measuring junction 25 and the cold junctions of the thermocouple 1 from the voltage or potential difference between the wires 1a, 1b of the thermocouple 1. The measuring circuitry typically bas a temperature sensor to determine the temperature of the cold junction and can therefore determine the temperature of the temperature measuring junction 25 at the distal tip of the temperature sensing device 10.

In preferred examples, the protection means includes at least three layers, such as a primary protection means, a secondary protection means and a tertiary protection means. The protection means may be configured as protective sheaths.

For example, the protective sheath 11 preferably includes (1) an innermost tertiary sheath 5 positioned adjacent to and surrounding the thermocouple 1 and thermocouple insulator 3, (2) an outermost primary sheath 9 surrounding the secondary sheath 7 and positioned to be exposed to the environment, and (3) at least one secondary sheath 7 between the at least one primary sheath and the at least one tertiary sheath.

The at least one tertiary sheath 5 is generally tubular and has an internal lumen 13 with a closed distal tip. The diameter of the internal lumen 13 is dimensioned such that the thermocouple wire 1a, 1b and thermocouple insulator 3 can be positioned therein.

The at least one tertiary sheath 5 is formed from sapphire, such as synthetic sapphire. Optionally, the tertiary sheath 5 may be provided as a single layer of sapphire or, alternatively, it may suitably be formed from multiple sapphire layers.

The at least one secondary sheath 7 is generally tubular and has an internal lumen 15 with a closed distal tip. The diameter of the internal lumen 15 is dimensioned such that the at least one tertiary sheath 5 can be positioned therein.

The at least one secondary sheath 7 may suitably comprise alumina, zirconium, mullite or a combination thereof. Preferably, the alumina is a high purity Al₂O₃, such as Al₂O₃ having a purity of 99.3% or higher, 99.5% or higher, 99.7% or higher, or 99.9% or higher Optionally, the at least one secondary sheath 7 may be provided as a single layer material or may suitably be formed from multiple layers of material.

The at least one primary sheath 9 is generally tubular and has an internal lumen 17 with a closed distal tip. The diameter of the internal lumen 17 is dimensioned such that the at least one secondary sheath 7 can be positioned therein. Optionally, the at least one primary sheath 7 may be provided as a single layer material or may suitably be formed from multiple layers of material.

The at least one primary sheath 9 may suitably comprise alumina, Zirconium, Mullite, sapphire, such as synthetic sapphire, or a combination thereof. Preferably, the primary sheath 9 is high purity Al₂O₃, such as Al₂O₃ having a purity of 99.3% or higher, 99.5% or higher, 99.7% or higher, or 99.9% or higher.

The protective sheath 11 is provided to be arranged around at least a portion of thermocouple wire 1a, 1b. The three-part protective sheath 11 is substantially resistant to degradation from the molten glass even without a precious metal thimble. The primary sheath 9 serves as sacrificial protective layer to the inner sapphire tertiary sheath 5. The sapphire tertiary sheath 5 significantly strengthens the three-part protective sheath 11 and provides protection to the thermocouple wire 1a, 1b that ultimately senses the temperature of the glass flowing within the glass furnace.

As the protective sheath 11 does not require a precious metal thimble, it may advantageously have an ultra-low content of precious metals, such as platinum, rhodium or the like. Advantageously, the protective sheath 11 may be free of precious metals, but this does not exclude the presence of unavoidable trace amounts of precious metals.

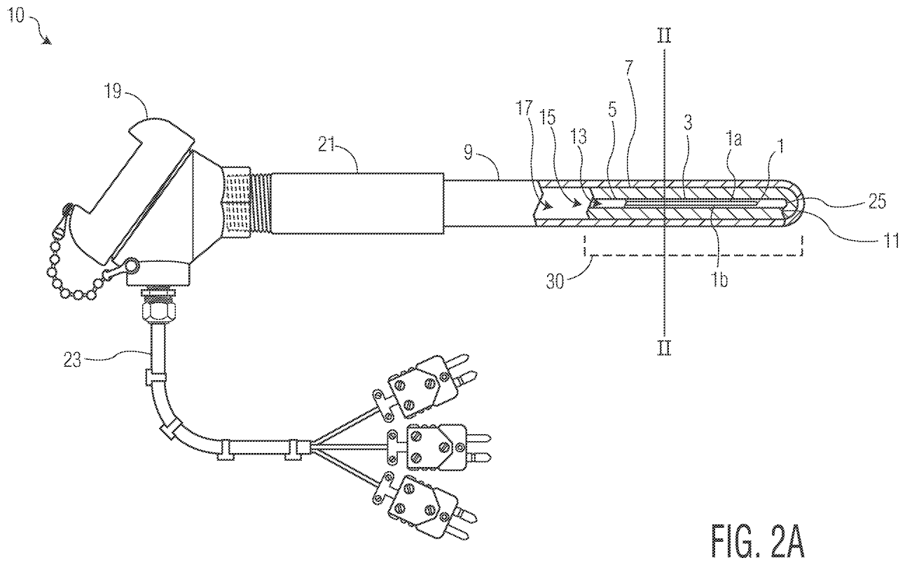

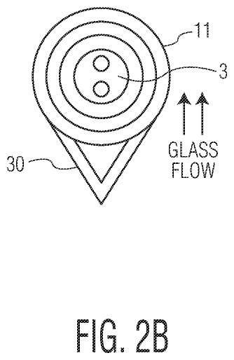

FIGS. 2A and 2B show an alternative example of an exemplary thermocouple device 10. The thermocouple device 10 includes a thermocouple wire 1, thermocouple insulator 3 and protective sheath 11 similar to thermocouple device 10. However, at least a portion of the length of the protective sheath 11 that will be submerged in molten glass is further provided with a fin 30. The fin 30 radially extends along a length of the protective sheath 11 and is preferably angled such that the fin defines an angled surface. An angled or contoured surface provided by the fin 30 provides additional erosion protection to the thermocouple device when the angle of the fin 30 is oriented against the direction of the glass flow.

As best seen in FIG. 2B, a transverse cross-section of the protective sheath 11 along line II-II of thermocouple device 10 has a tear-drop shape. A space between the fin 30 and the protective sheath 11 may be filled with ambient air or a ceramic material, such as a ceramic potting compound, or other suitable materials. The fin 30 may be formed of the same material or different material as the protective sheath 11.

Suitably, the fin 30 may be formed from a strip of material that is bent at an angle and joined along longitudinal edges to the protective sheath 11. For example, the fin 30 may be formed from a strip of material that is bent at a 90° angle and joined to the protective sheath the along an arc length of the protective sheath 11 at 90°. Other dimensions are possible, including a fin defining an angled surface having an angle of less than 90°, less than 80°, less than 70°, less than 60°, less than 50° or less than 40°.

Certain embodiments and features have been described using a set of numerical upper limits and a set of numerical lower limits. It should be appreciated that ranges including the combination of any two values (e.g., the combination of any lower value with any upper value, the combination of any two lower values, and/or the combination of any two upper values) are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

Although only a few examples have been described in detail above, those skilled in the art will readily appreciate that many modifications can be possible in the examples without materially departing from this subject disclosure. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw cannot be structural equivalents in that a nail employs a cylindrical surface to secure wooden parts together, whereas a screw employs a helical surface, in the environment of fastening wooden parts, a nail and a screw can be equivalent structures. It is the Applicant's express intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A temperature sensing device comprising:
a thermocouple having a pair of wires, a temperature measuring junction between the wires, and an insulator covering the wires; and
a protective sheath comprising:
a tertiary sheath surrounding the wires, the temperature measuring junction, and the insulator of the thermocouple,
a secondary sheath surrounding the tertiary sheath, and
a primary sheath surrounding the secondary sheath;
wherein the tertiary sheath contains sapphire.

2. The temperature sensing device of claim 1, wherein the primary sheath contains at least one of sapphire, alumina, zirconium, mullite or a combination thereof.

3. The temperature sensing device of claim 1, wherein the secondary sheath contains at least one of alumina, zirconium, mullite or a combination thereof.

4. The temperature sensing device of claim 1, wherein the primary sheath or the secondary sheath comprise multiple layers.

5. The temperature sensing device of claim 1, further comprising a fin extending along a length of the protective sheath.

6. The temperature sensing device of claim 5, wherein the fin extends along a length of the thermocouple device configured to contact a molten material.

7. The temperature sensing device of claim 5, wherein the fin defines an angled surface.

8. The temperature sensing device of claim 1, wherein the primary sheath contains high purity alumina and the secondary sheath contains high purity alumina.

9. The temperature sensing device of claim 1, wherein the protective sheath is free of precious metal.

10. A temperature sensing device comprising:
a temperature sensor for measuring a temperature of an environment; and
a protection means for protecting the temperature sensor comprising:
a tertiary protection means surrounding the temperature sensor,
a secondary protection means surrounding the tertiary protection means, and
a primary protection means surrounding the secondary protection means;
wherein the tertiary protection means contains sapphire.

11. The temperature sensing device of claim 10, wherein the primary protection means contains at least one of sapphire, alumina, zirconium, mullite or a combination thereof.

12. The temperature sensing device of claim 10, wherein the secondary protection means contains at least one of alumina, zirconium, mullite or a combination thereof.

13. The temperature sensing device of claim 10, wherein the primary protection means or the secondary protection means comprise multiple layers.

14. The temperature sensing device of claim 10, further comprising a fin extending along a length of the protection means.

15. The temperature sensing device of claim 14, wherein the fin extends along a length of the temperature sensor configured to contact a molten material.

16. The temperature sensing device of claim 14, wherein the fin defines an angled surface.

17. The temperature sensing device of claim 10, wherein the protection means is free of precious metal.
